(19) United States
(12) Patent Application Publication
(10) Pub. No.: US 2009/0137224 A1
(43) Pub. Date: May 28, 2009

(54) Computer-assisted telephony system

(76) Inventors: Jean-Francois Peyre, Rousset (FR); Jean-Luc Grand-Clement, Paris (FR)

Correspondence Address: Horst M. Kasper, 13 Forest Drive, Warren, NJ, 07059, US

(21) Appl. No.: 11/666,447

(22) PCT Filed: Oct. 26, 2005
(86) PCT No.: PCT/FR05/00281

§ 371 Date: Jun. 25, 2007

(30) Foreign Application Priority Data
Oct. 26, 2004 (FR) 0411380

(51) Int. Cl. H04M 11/04; H04M 3/42

(52) U.S. Cl. 455/404.2; 455/417

(57) ABSTRACT

The invention relates to a telephony system whose users (11, 12, 13), being provided with a simplified fixed or mobile telephone terminal devoid of a screen and a keyboard, initiate a call by merely manipulating a handset, a button or a flap in order to be connected to an operator (14) accessing to a database (15) which provides said operator with references of the calling person and instructions, their telephone contacts list and their useful medical data. Said database is updated by subscribers or authorized third parties using the Internet, electronic mail or telephone. A simplified terminal is remotely programmed, in particular to define a number to call according to the availability of operators or to adjust the ringer volume according to the time, for example. The transfer to a desired contact can be carried out by the terminal itself, which receives from the operator an instruction indicating the number to call, for example by means of voice frequencies.

The subject matter of the present invention is a telephony system in which the caller uses a highly-simplified terminal and is assisted by a network of non-centralized operators having access to a database of the preferences of callers, with an option for locating the caller, these means enabling the services offered by the operator to be optimized, especially in an emergency.

The current trend in fixed or mobile telephony systems is to offer services that provide better and better performance but that are also more and more sophisticated. Moreover, there is clearly a trend, for operating cost reasons, towards replacing human operators by automated systems that the user controls by means of the keys of the keypad or by speaking. As a result of this increasing complexity of services, combined with their automation, a large number of potential users are put off and excluded from these services.

The object of the present invention is to remedy this exclusion by providing an extremely simplified terminal with a system for interactive exchange of data on-line and a network of non-centralized operators to create an assisted telephony service that offers high performance and is user friendly, flexible, customizable, and very simple to access.

The system can optionally offer a service for tracking and updating telephone coordinates of institutional contacts and professional service providers, and can even propose new services to callers requiring this.

The database can also contain the coordinates of contacts able to provide assistance, whether as individuals or as members of associations or of mutual support services, ready to talk to callers to provide them with information, comfort, a sympathetic ear, or a visit. Such contacts providing assistance could inform the network of their availability, their areas of skills or interest and where applicable callers with whom they no longer wish to talk, in advance, and in real time,

The present invention describes an operator-assisted telephony system in which a user (11, 12, 13) who subscribes to the system is provided with a simplified fixed or mobile telephone terminal that has no screen or keyboard and can take the form of a pendant or a wristwatch, and by which, when the user initiates a call simply by manipulating a handset, a button, a flap or any other electromechanical device or by speaking, the user is connected directly to an operator (14), said operator accessing in real time a database (15) that, immediately the call is received, provides the operator with the references, preferences and instructions of said caller, in particular the caller's list of telephone contacts and medical data useful in an emergency, and assists said operator to connect said caller with the required contact (16) or service, to deal with an emergency, to relay a request or to supply the caller with requested information.

The performance of the proposed system stems from the fact that the database can be updated by subscribers, operators, and authorized third parties, in particular by means of an Internet-type computer link, electronic mail, or telephone, and the simplified telephone terminal can be remotely programmed, either automatically by the database or manually by persons who have the activation code for that service, for example by means of instant messaging or electronic mail, in particular to define the number to be called as a function of the availability of potential operators or to adjust the ringer volume as a function of the time or the user's preferences, for example.

The operators work remotely, for example from home, but can indicate their availability or unavailability to the network in advance and also in real time, enabling the network to connect callers to the operators who are available whilst using its best efforts to connect a caller with the caller's usual or preferred operators.

The operator advantageously also receives automatically information on the geographical location of the caller, enabling the operator in particular to decide on the best service to connect the caller to in an emergency.

The caller can advantageously request to the operator to pass on later to a designated contact a voice or text message that the caller dictates to the operator and can be sent by telephone, electronic mail, facsimile, a simplified messaging system, or any other appropriate means.

In a preferred embodiment, the contacts listed in the database can have the option of reporting their degree of availability, their location, and the telephone number at which to contact them, in advance and also in real time.

The contacts listed in the database can advantageously have the option of serving temporarily or permanently as the operator for at least one of the subscriber callers and of then being able to offer at least some of the services offered by the usual operators.

In a preferred embodiment, at least some of the operators use a high bit rate Internet link to communicate with callers, connect them to a selected contact, or receive pertinent information from the database on their terminal in real time.

To favor a more rapid response, a call can advantageously be signaled to several of the operators declared to be available or to all of them,

An emergency call can be triggered by prolonged and continuous pressing of the call button, by specific manipulation of the flap, or by pressing the button on a detachable pendant usable remotely from the terminal. In an emergency, the terminal can then call a national number, such as 112 in Europe, instead of the usual operator.

In emergency, a call can also be processed by a plurality of operators in parallel, either immediately the call is received or subsequently, after this requirement is reported by the operator who initially responds, the network management system managing the collaboration between the operators.

A user can advantageously request that calls to the user be filtered by the operators of the network in accordance with instructions recorded in the database, for example telling the operator, as a function of the caller, the time or other predefined parameter, to transfer the call to the user, to refuse it, to take a message, or to send a message to the caller.

Similarly, a user can request that voice, text, facsimile, or electronic mail messages to that user be received by the operator of the network and notified to the user by telephone, read out, responded to, or sent to the user by mail, depending on instructions.

A user can advantageously request the operator to connect the user to the requested contact by simply entering the number (direct transfer), after checking that the line is available (assisted transfer), or after checking that the contact answers (manual transfer), including if that requires waiting for the called party to become available or entering more than one number.

In a preferred embodiment, the connection to the requested contact is effected by the operator sending voice frequency (DTMF) commands:
For example, the operator identifies the called party with the aid of the database and sends a voice frequency command to the terminal. That command is received and interpreted by the terminal:
   If a short command such as #12# is sent, the terminal interprets it as the address of the number of the contact in the contacts list of the terminal and selects that number.
   If a command such as #012237207# is sent, the terminal interprets it as the complete number of the contact.

The terminal then enters said number and is connected to the contact, optionally remaining connected to the operator for a three-way call, depending on whether another code is sent by the operator.

Such a connection system means that the operator does not need a switching system.

Moreover, the operator can advantageously inform the caller, systematically or at the caller's request, as to the status of the caller's telephone consumption and the data transmitted by the caller's terminal at the time of the call, for example location data, the state of charge of the rechargeable battery, or even measurements of physiological data effected by sensors connected to the terminal. This function can also be provided by a voice synthesizer system integrated into the terminal.

The telephone terminal advantageously has a full keyboard, and possibly a screen, which are concealed in a normal mode of operation, for example by a flap, to allow only simplified working with direct access to the network of operators in that mode of operation.

In a preferred embodiment, the simplified terminal can be programmed to respond automatically in ‘hands-free’ mode to all calls or to only those calls that emanate from authorized callers, and to do so systematically, as a function of an action of the user, or as a function of a code sent by the caller.

The simplified terminal is advantageously provided with means for signaling, repetitively if necessary, a low level of charge in its energy source, battery or rechargeable battery, in the form of a visual message, such as a flashing indicator light, a sound signal, or an electronic message sent to the network to prompt the intervention of the operator.

The callers can use simplified fixed telephone terminals connected to the standard switched telephone network or using the Internet Protocol or simplified ‘wireless’ telephone terminals consisting of a fixed base connected to the telephone network and a mobile terminal communicating with said base by a short-range or medium-range radio link, for example using the DECT, ISM, WIFI, or WIMAX standards, which base can then be equipped with more complex functions than said simplified mobile terminal.

The callers can also use mobile, portable, or vehicle-mounted telephone terminals connected to a mobile telephone network operating with the GSM, PCS, DCS, or CDMA standards, for example, and provided with means for initializing them automatically as soon as they are switched on, for example without needing to enter an initialization code.

In a preferred embodiment of the present invention, the simplified telephone terminal includes an inclination sensor, for example a static accelerometer for adjusting terminal operation intuitively. For example, the power supply from the terminal can be cut off if a single button is pressed for a long time with the front face of the terminal facing downwards. Also, the ‘hands-free’ mode can be entered if, during a call, the terminal is laid flat with the front panel uppermost. An emergency call can also be detected if the terminal is strongly agitated.

The integrated acceleration sensor can advantageously be used to identify the caller by prompting the caller to register and subsequently to repeat an electronic signature that consists of a sequence of movements of the terminal and can be used to authorize the initialization of the terminal or any type of remote transaction that may require authentication by the caller.

The invention can be better understood and its other objects, advantages and features become more clearly apparent on reading the following description of preferred embodiments, which is given by way of non-limiting example and to which are appended drawings in which:

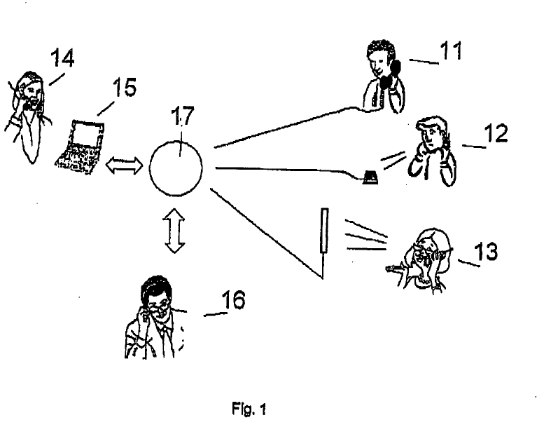

FIGS. 1 to 5 are diagrammatic views of certain embodiments of the present invention.

FIG. 1 shows diagrammatically the telecommunications network and the various parties,

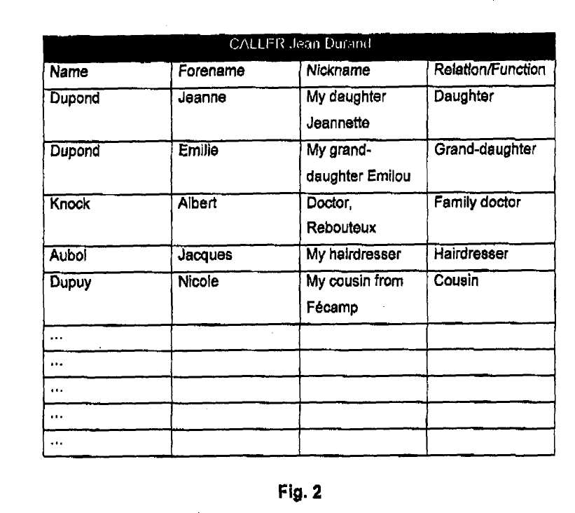

FIGS. 2 to 4 show one implementation of the main screens used by operators that display information from the database.

FIG. 5 illustrates diagrammatically one embodiment of the simplified telephone terminal of the present invention, here provided with a flap shown respectively in its closed position (51) on standby when not communicating and in its open position (52) for initiating or responding to a call.

Referring to FIG. 1, note the existence of three types of party:
users who subscribe to the system (11, 12, and 13);
non-centralized operators (14); and
the contacts (16) of the subscribers.

A switching system (17), which may optionally be centralized, first connects the caller and the operator and then connects caller and the caller's contact, freeing the operator when the operator's assistance with the transfer is completed, switching.

This system must be able to determine to which operator to route a call from a subscriber user as a function of the availabilities of the operators and the preferences of the caller.

Optionally, this system may also be adapted to manage a situation where a plurality of operators process the same call in parallel and a situation where the subscriber has requested filtering of incoming calls.

This switching system (17) advantageously makes use of high bit rate networks utilizing the Internet Protocol.

The users (11, 12, 13) can use any type of terminal, including standard terminals on which they have to enter the number of the operator network. They preferably use a simplified terminal into which the number of the network is programmed so that it is dialed automatically, for example when the handset is picked up, a flap is opened or a button is pressed. This terminal may be a terminal (11) that is connected in fixed manner to the switched or other telephone network, It may also be a terminal (12) that has a local radio link to a base station connected to the network or a mobile terminal (13) communicating with a cellular telephony network. The terminal includes means for automatically sending its identification and optionally its location.

That location is stored for a fixed or local radio link terminal and supplied by a geolocation system with terrestrial or satellite stations, such as the GPS or Galileo systems for example, possibly assisted by the coarse geolocation supplied by the cellular network.

The users (11, 12, 13) can be called in the conventional way, unless they have requested the operator filtering option. They respond to a call by operating the button, lever, flap, or handset of their simplified terminal.

They can decide independently to activate or deactivate a ringer or a vibrator, or can request the operator to program such a function.

They can also adjust the sound volume of the receiver, for example to operate in ‘hands-free’ mode without having to hold the receiver to the ear, such adjustment possibly be effected intuitively by means of an inclination sensor integrated into the terminal.

They can moreover adjust their terminal so that it automatically responds in ‘hands-free’ mode to any incoming call, for example by laying the terminal flat with the front panel uppermost.

The database management system could display the pages shown in FIGS. 2, 3 and 4, for example:

FIG. 2: List of usual contacts: neighbors, family, usual suppliers and service providers, administrative contacts.

This list is organized for locating the required contacts as quickly as possible, in particular by listing nicknames that a caller might use. These nicknames can be updated in real time by the operator.

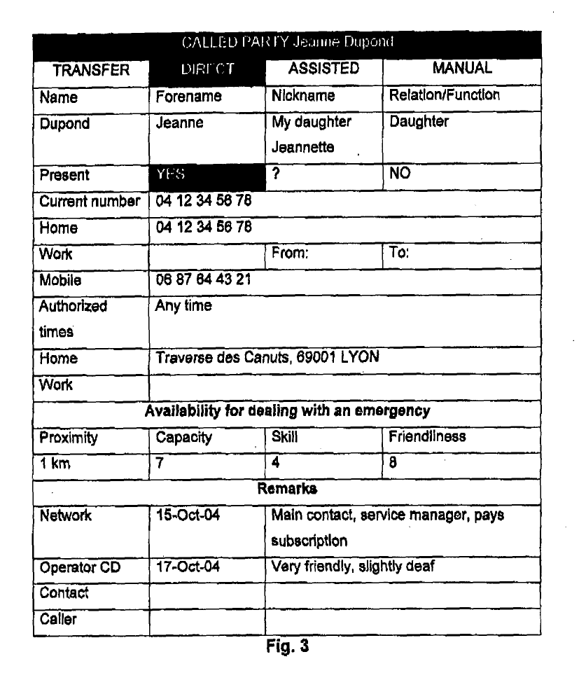

FIG. 3: For each contact, a page specifying their coordinates, beginning with their recommended telephone number, which is updated continuously by the system as a function of the usual schedules and any reported unavailability of the contact, and their location.

Remarks can be added and modified by the various parties (callers, contacts, and operators).

The transfer mode required by the caller is indicated.

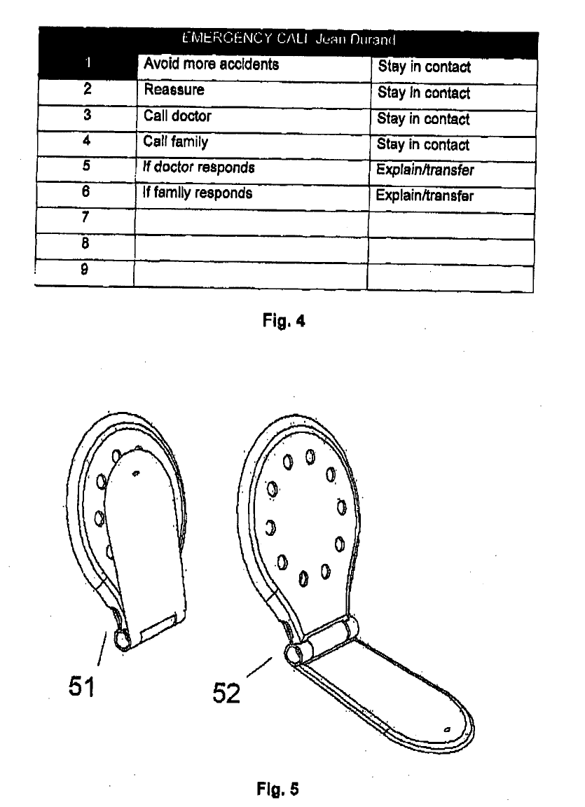

FIG. 4: A page specifying what to do in an emergency, which is updated by the system as a function of the schedule and the location of the caller if the location is relayed automatically or specified vocally by the caller.

An emergency call report can be generated automatically by the system to make events traceable.

The operator is largely guided by the system in navigating between the various pages, and enters data using any appropriate and conventional means, such as a keyboard, mouse, touch-sensitive screen, or light-pen, for example. The operator does not have to enter a programmed number manually, since it Suffices merely to indicate it on the screen.

The present invention therefore provides a novel association of the capacities of present-day electronic data processing systems with the technical possibilities of modern telecommunication networks to create an effective and intuitive telephony service adapted to persons with little familiarity with the technology.

The present invention is naturally addressed to elderly persons, dependent persons, and young children.

It is equally addressed to all persons wishing to have a simple, intuitive, and lightweight means of communication, for example as a means of seeking assistance and rescue in particular situations such as outdoor sports activities.

It is also addressed to persons requiring a non-intrusive telephone system, who can opt to have the operators filter incoming calls.

The positioning of the various components gives the invention a maximum of useful effects that has not previously been obtained from similar devices.

1. Operator-assisted telephony system in which a user: (11, 12, 13) subscribing to the system is provided with a simplified fixed or mobile telephone terminal that has no screen or keyboard and can take the form of a pendant, and by which, when the user initiates a call simply by manipulating a handset, a button, a flap or any other electromechanical device or by speaking, the user is connected directly to an operator (14), said operator accessing in real time a database (15) that, immediately the call is received, provides the references, preferences and instructions of the caller, in particular a list of the caller's telephone contacts and medical data useful in an emergency, and assists said operator to connect the caller with the required contact (16) or service, to deal with an emergency, to relay a request or to supply the caller with requested information;
said system being characterized in that said database can be updated in real time by subscribers, operators, and authorized third parties, in particular by means of an Internet type computer link, electronic mail, or telephone, and the simplified telephone terminal can be remotely programmed either automatically by the database or manually by persons having the appropriate service activation code, for example by means of a messaging or electronic mail system, in particular to define the number to be called as a function of the availability of potential operators and to adjust the ringer volume as a function of the time, for example.

2. A telephony system according to claim 1, characterized in that said operator also receives automatically information on the geographical location of the caller, enabling the operator in particular to decide on the best service to connect the caller to in an emergency.

3. A telephony system according to claim 1, characterised in that the caller can dictate to the operator a voice or text message and request the operator to transmit it to a designated contact by telephone, electronic mall, facsimile, simplified messaging system, or any other appropriate means.

4. A telephony system according to claim 1, characterized in that the contacts listed in the database can report their availability and the telephone numbers at which to contact them in advance and also in real time.

5. A telephony system according to claim 1, characterized in that the contacts listed in the database can have the option of serving temporarily or permanently as the operator for at least one of the subscriber callers and of then being able to offer at least some of the services offered by the usual operators.

6. A telephony system according to claim 1, characterized in that at least some of the operators use a high bit rate Internet link to communicate with callers, connect them to a selected contact, or receive pertinent information from the database on their terminal in real time.

7. A telephony system according to claim 1, characterized in that, to favor a more rapid response, a call is signaled to several of the operators declared to be available or to all of them.

8. A telephony system according to claim 1, characterized in that an emergency call can be triggered either by prolonged and continuous pressing of a call button, by specific manipulation of a flap, or by pressing the button on a detachable pendant usable remotely from the terminal, which can be programmed to call a national number, such as 112 in Europe, instead of the usual operator.

9. A telephony system according to claim 1, characterized in that a call be processed by a plurality of operators in parallel, at least in an emergency, either immediately the call is received or subsequently, after this requirement is reported by the operator who initially responds, the network management system managing the collaboration of the operators.

10. A telephony system according to claim 1, characterized in that a user can request that calls to the user be filtered by the operators of the network according to instructions recorded in the database, for example telling the operator, as a function of the caller, the time or other predefined parameter, to transfer the call to the user, to refuse it, to take a message or to send a message to the caller.

11. A telephony system according to claim 1, characterized in that a user can request the operators of the network to receive voice, text, facsimile, or electronic mail messages to that user in order to transmit them to the user by telephone, mail, or any other communication means and optionally to assist the user to answer them.

12. A telephony system according to claim 1, characterized in that a user can request the operator to connect the user to a requested contact by simply entering the number (direct transfer), after checking that the line is available (assisted transfer), or after checking that the contact answers (manual transfer), including if that requires waiting for the called party to become available or entering more than one number.

13. A telephony system according to claim 1, characterized in that the connection to a requested contact is effected by the operator sending voice frequency (DTMF) commands interpreted by the terminal as the address of the number of that contact in the contact list of the terminal or the complete number of that contact, so that the terminal enters said number and is connected to the contact, remaining connected to the operator or not, such a system avoiding the operator needing to have a switching system.

14. A telephony system according to claim 1, characterized in that, by means of an integrated voice synthesizer system, the operator or the terminal can inform a caller, systematically or at the caller's request, as to the status of the caller's telephone consumption and the data transmitted by the caller's terminal at the time of the call, for example location data, the state of charge of the rechargeable battery or even measurements of physiological data effected by sensors connected to the terminal.

15. A telephony system according to claim 1, characterized in that said operator works remotely, for example from home, but has means for reporting his or her own availability or unavailability to the network in advance but also in real time, enabling the network to route callers to the available operators, whilst using its best efforts to connect a caller to that caller's usual or preferred operators.

16. A telephony system according to claim 1, characterized in that the telephone terminal has a full keyboard, and possibly a screen, which are concealed in a normal mode of operation, for example by a flap, to allow only simplified working with direct access to the network of operators in that mode of operation.

17. A telephony system according to claim 1, characterized in that the simplified terminal can be programmed to respond automatically in ‘hands-free’ mode to all calls or to only those calls that emanate from authorized callers, and to do so systematically, as a function of an action of the user, or as a function of a code sent by the caller.

18. A telephony system according to claim 1, characterized in that the simplified terminal is provided with means for signaling, repetitively if necessary, a low level of charge in its energy source, battery or rechargeable battery, in the form of a visual message, such as a flashing indicator, a sound signal or .an electronic message sent to the network to prompt the intervention of the operator.

19. A telephony system according to claim 1, characterized in that at least some callers use simplified ‘wireless’ telephone terminals consisting of a fixed base connected to the telephone network and a mobile terminal communicating with said base by a short-range or medium-range radio link, for example using the DECT, ISM, WIFI or WIMAX standards, which base can then be equipped with more complex functions than said simplified mobile terminal.

20. A telephony system according to claim 1, characterized in that at least some callers use mobile, portable or vehicle-mounted telephone terminals connected to a mobile telephone network operating with the GSM, PCS, DCS or CDMA standards, for example, and provided with means for initializing them automatically as soon as switched on.

21. A telephony system according to claim 1, characterized in that the simplified telephone terminal includes an inclination or acceleration sensor for detecting the orientation and movement of the terminal and adjusting its operation intuitively, for example to cut off the power supply from the terminal if a single button is pressed for a long time with the front face of the terminal facing downwards, to enter the ‘hands-free’ mode if, during a call, the terminal is laid flat with the front panel uppermost, or to trigger an emergency call if the terminal is strongly agitated.

22. A telephone system according to claim 21, characterized in that the integrated inclination or acceleration sensor is used to identify the caller by prompting the caller to register and subsequently to repeat an electronic signature that consists of a sequence of movements of the terminal and can be used to authorize the initialization of the terminal or any type of remote transaction that may require authentication by the caller.

23. Telephone installation comprising an assisted telephony system and at least one terminal,
said terminal being provided with control means for connecting with the system and forwarding its identification to it,
the system including:
a database in which states a list of partners' numbers associated with said identification,
assisting means for connecting said terminal with one partner,
means for updating the database through the terminal, wherein:
control means showing exclusively two (stable) states, they belong to the set comprising electromechanical devices and vocal devices,
updating means are informed through one unit of the set comprising said assisting means and the other terminals, and
the terminal is remotely programmed by said assisting means.
